(19) United States
(12) Patent Application Publication
(10) Pub. No.: US 2013/0061012 A1
(43) Pub. Date: Mar. 7, 2013

(54) VIRTUAL MACHINE CODE INJECTION

(71) Applicants: Yoshio Turner, San Francisco, CA (US); Jose Renato G. Santos, San Jose, CA (US)

(72) Inventors: Yoshio Turner, San Francisco, CA (US); Jose Renato G. Santos, San Jose, CA (US)

(21) Appl. No.: 13/696,981

(22) PCT Filed: May 30, 2010
(86) PCT No.: PCT/US10/36786

§ 371 Date: Nov. 8, 2012

(51) Int. Cl. G06F 12/12

(52) U.S. Cl. 711/159; 711/E12.07

(57) ABSTRACT

A memory has a page to store code executable by a processor. A management component is to inject the code into a virtual machine. The management component is to indicate within a memory table for the virtual machine that the page of the memory has an injected code type.

### BACKGROUND

An increasingly popular type of computer architecture is one that employs virtual machines. One or more computing devices host one or more virtual machines, each of which can correspond to a different end user. Each end user uses a terminal, or other type of client computing device that is communicatively connected to the computing devices, to provide input to a virtual machine and to receive output from the virtual machine. Processing of the input to generate the output, however, is handled by the computing devices that host the virtual machines. Each virtual machine has its own dedicated copy of an operating system, which is referred to as a guest operating system and that is installed at the computing devices. The terminals or other types of client computing devices thus perform limited or no processing functionality.

### BRIEF DESCRIPTION OF THE DRAWINGS

FIG. 1 is a diagram of a computing system, according to an example embodiment of the present disclosure.

FIG. 2 is a diagram depicting how secure code injection is provided, according to an example embodiment of the disclosure.

FIG. 3 is flowchart of a method performed at least in part by a management component to provide for secure code injection, according to an example embodiment of the disclosure.

FIG. 4 is a flowchart of a method performed by a processor to provide for secure code injection, according to an example embodiment of the disclosure.

FIG. 5 is a flowchart of a method performed by a processor and a memory controller to provide for secure code injection, according to an example embodiment of the disclosure.

### DETAILED DESCRIPTION

As noted in the background section, virtual machines have become increasingly popular. Generally, the virtual machines hosted on one or more computing devices share the hardware resources of the computing devices. Input/output (I/O) requests from the virtual machines to the hardware resources may be processed in one or two different modes. In a direct mode, the I/O requests are directly sent from the virtual machines to the hardware resources, for enhanced performance. In an indirect mode, the I/O requests generated by the virtual machines are intercepted for additional processing before being sent to the hardware resources. The indirect mode permits enhanced I/O services to be provided, such as packet inspection, filtering, intrusion and virus detection, logging, and auditing, among other types of such services.

When a virtual machine operates in the direct mode, the virtual machine typically includes code specific to the hardware resources to permit the virtual machine to access the hardware resources. If the virtual machine is to operate on a wide variety of different computing devices having a correspondingly wide variety of different hardware resources, the virtual machine thus has to include code specific to each hardware resource that the virtual machine may potentially access. This is disadvantageous, because including such code increases the size of the virtual machine. Furthermore, maintaining the virtual machine becomes difficult to ensure that the virtual machine has the latest versions of the code and has specific code for new hardware resources.

To overcome this problem, a recent approach injects code specific to a given hardware resource on as-needed basis into a virtual machine for the virtual machine to directly access this hardware resource. For example, a hypervisor managing a virtual machine identifies the hardware resources of the computing devices that are hosting the virtual machine, and determines which of these hardware resources this virtual machine is to access. The hypervisor inserts, or adds, code specific to these hardware resources directly into the virtual machine, in a process known as code injection. The virtual machine thus does not include code specific to all the different types of hardware resources of all the different types of computing devices that may potentially host the virtual machine. Rather, the hypervisor injects code just for those hardware resources that the virtual machine is to use.

For example, when a virtual machine is to be deployed on a given computing device, at the time of deployment the hypervisor may inject code into the virtual machine so that the virtual machine can access the hardware resources of this computing device. At a later point in time, the virtual machine may be migrated from this computing device to a new computing device, where the new computing device has different hardware resources than the original computing device. As such, the previously injected code for the hardware resources of the original computing device is removed from the virtual machine. The hypervisor then injects different code into the virtual machine so that the virtual machine can access the hardware resources of the new computing device.

A disadvantage to code injection, however, is that it raises security concerns. The virtual machine may be able to execute the code in such a way as to circumvent any security precautions that may be present within the code. For example, the virtual machine may be able to execute isolated portions of the code in such a way that the security precautions within the code are circumvented. As another example, even if the code is injected into the virtual machine in such a way that the virtual machine is unable to make changes to the code, the virtual machine may make a copy of the code and in the process make changes to the code that permit the virtual machine to circumvent any security precautions within the code. As such, these security concerns make it pragmatically infeasible to provide for enhanced I/O services using the direct mode via code injection, such that these enhanced I/O services can generally be currently provided just by using the indirect mode, which disadvantageously has lower performance than the direct mode does.

Embodiments of the disclosure remedy this disadvantage to code injection. The hypervisor or other management component injects code into a virtual machine by storing the code at a given memory page. The hypervisor indicates within a memory table for the virtual machine that this memory page has an injected code type, and also indicates a permitted entry point within the code. The processor is to reject entry into the code except at the permitted entry point. In this way, the virtual machine cannot execute isolated portions of the code to circumvent security precautions within the code, because execution of the code has to start at the permitted entry point.

The code may permit the virtual machine to access a hardware resource via memory-mapped IO (MMIO) requests executed by the processor. A memory controller is modified so that the MMIO requests are blocked if the requests do not originate from a memory page having the injected code type. In this way, the virtual machine cannot copy the code and in the process make changes to the code that permit the virtual machine to circumvent any security precautions within the code while still being able to access the hardware resource in question. This is because the virtual machine cannot itself indicate within the memory table that the memory page at which the copied and modified version of the code is stored has the injected code type, such that the memory controller prevents this version of the code from accessing the hardware resource.

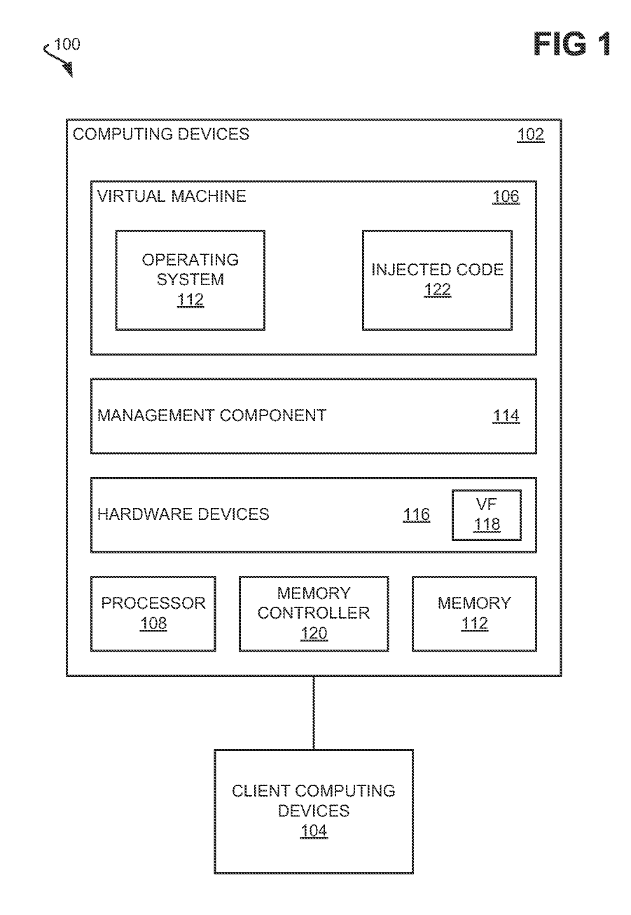

FIG. 1 shows a computing system 100, according to an example embodiment of the disclosure. The computing system includes one or more computing devices 102 and one or more client computing devices 104. Each of the computing devices 102 and 104 includes hardware, such as a processor 108, memory 112, and a memory controller 120. The memory controller 120 interfaces the processor 108 to the memory 112 to permit the processor 108 to access the memory 112.

In one embodiment, the term memory controller as used herein refers to a controller such as a memory management unit (MMU), or another type of controller that provides relatively high-level control of the memory 112. The memory controller in this embodiment thus does not refer to a memory control circuit or other controller that provides relatively low-level control of the memory 112. For example, the memory controller in this embodiment does not refer to a controller that generates row-access strobe (RAS) and column-access strobe (CAS) signals to dynamic-random access memory (DRAM).

Each of the computing devices 102 and 104 can include other hardware as well, such as hardware devices like input devices, output devices, network devices and so on. An exemplary such hardware device is specifically called out in FIG. 1 as the hardware device 116. Users provide input at the client computing devices 104, which is sent to the computing devices 102 for processing to generate output. The output is then sent from the computing devices 102 back to the client computing devices 104, at which the output is displayed for the users.

In this respect, the computing devices 102 include a virtual machine 106 having an operating system 110 that runs on and that are implemented by the hardware of the computing devices 102. For instance, the virtual machine 106 may be implemented by code stored at least in part within the memory 112 and that is executed by the processor 108. A virtual machine is an instance of an operating system along with one or more applications running in an isolated partition within the computing devices 102. Virtual machines permit the same or different operating systems to run on the same computing devices 102 at the same time while preventing the virtual machines from interfering with each other. Each virtual machine is considered a “machine within the machine” and functions as if it owned an entire computing device. While just one virtual machine 106 is depicted in FIG. 1, in actuality there can be more than one such virtual machine.

The operating system 110 can be referred to as a guest operating system. Different virtual machines can have the same or different versions of the same or different operating systems. Such operating systems may include versions of the LINUX® operating system, where LINUX® is a trademark of Linus Torvalds. Such operating systems may further include versions of the Microsoft® Windows® operating system, where Microsoft® and Windows® are trademarks of Microsoft Corp., of Redmond, Wash.

The management component 114 manages the virtual machine 106 and assists in the virtualization of the hardware device 116 for use by the virtual machine 106. The management component 114 also may be stored at least in part within the memory 112 and executed by the processor 108. The management component 114 may be referred to as virtualization software, as a virtual machine monitor (VMM), or as a hypervisor. An example of the management component 114 is Xen® virtual machine software, available from Citrix Systems, Inc., of Ft. Lauderdale, Fla. Another example of the management component 114 is VMware® virtual machine software, available from VMware, Inc., of Palo Alto, Calif. The management component 114 manages the virtual machine 106 in that, among other things, the management component 114 controls the instantiation, migration, and deletion of the virtual machine 106.

The hardware devices 116 can provide a virtual function 118. The virtual function 118 virtualizes the functionality provided by the hardware device 116, to assist the management component 114 in virtualizing the device 116 for use by the virtual machine 106. That is, the virtual machine 106 can access the hardware device 116 directly using the virtual function 118, instead having to access the hardware device 116 more indirectly, via or through the management component 114. The virtual function 118 can in one example embodiment be a peripheral component interconnect (PCI) Express (PCIe) virtual function that is provided or exposed by a PCIe device hardware where the device is single root input/output virtualization (SR-IOV) capable.

The operation of the virtual machine 106 in the direct mode is described herein in relation to I/O requests generated by the virtual machine 106 that are intended for the hardware device 116 providing the virtual function 118. The virtual machine 106 operates in the direct mode via code 122 that the management component 114 has injected into the virtual machine 106. Like the virtual machine 106, the injected code 122 is stored within the memory 112 and is executed by the processor 108. The injected code 122 is particular to the hardware device 116, where the hardware devices 116 can also be referred to as a hardware resource of the computing devices 102. In the direct mode, the virtual function 118 is owned by the virtual machine 106. More specifically, in the direct mode, I/O requests generated by the virtual machine 106 are sent directly to the virtual function 118 of the hardware device 116, by the injected code 122.

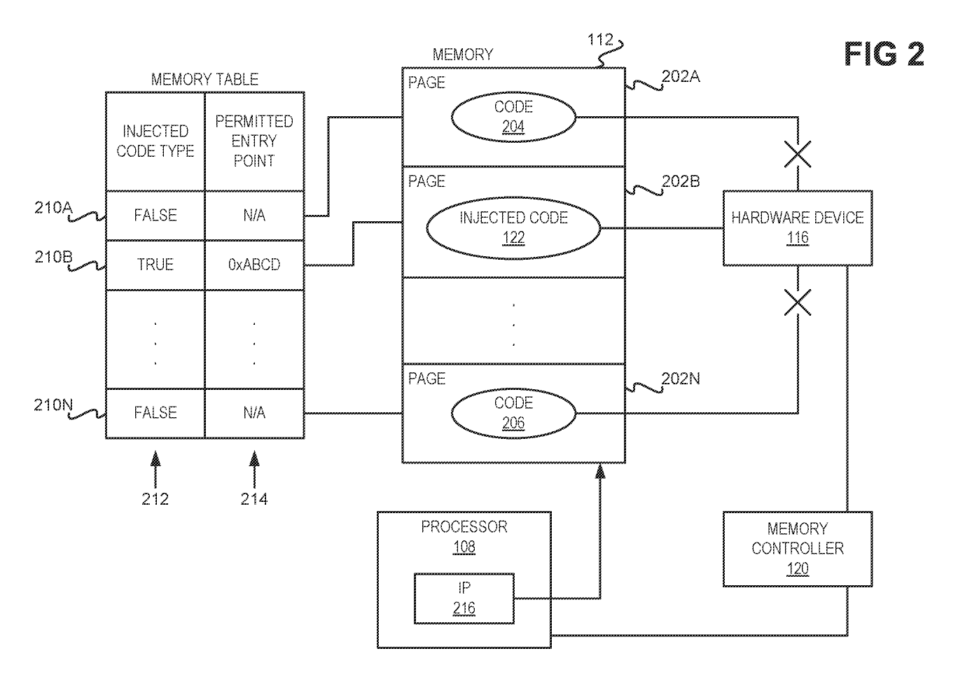

FIG. 2 illustratively depicts how the management component 114 can provide for secure injection of the code 122 into the virtual machine 106, according to an example embodiment of the disclosure. The memory 112 is divided into pages 202A, 202B, . . . , 202N, collectively referred to as the pages 202. Each page 202 is a contiguous portion of the memory. The terminology “page” is not otherwise used in a specific sense herein. The pages 202 store code of the virtual machine 106, where the pages 202A and 202N are called out in FIG. 2 as specifically storing the code 204 and 206, respectively, and where the page 202B is called out in FIG. 2 as specifically storing the injected code 122.

The processor 206 maintains an instruction pointer 216, which references the next code instruction to be executed by the processor 108. That is, the code 122, 204, and 206 is made up of a number of code instructions, where the next code instruction to be executed by the processor 108 is referenced by the instruction pointer 216. Once the processor 108 has executed the code instruction referenced by the instruction pointer 216, the instruction pointer 216 refers to a new code instruction to be executed by the processor 108.

The management component 114 maintains a memory table 208 for the virtual machine 106. The virtual machine 106 cannot modify the memory table 208, even though the memory table 208 is being maintained by the management component 114 for the virtual machine 106. The memory table 208 has a number of rows 210A, 210B, . . . , 210N, which are collectively referred to as the rows 210, and which correspond to the pages 202 of the memory 112. As such, the row 210A corresponds to the page 202A, the row 210B corresponds to the page 202B, and the row 210N corresponds to the page 202N. Each row 210 includes values for two fields 212 and 214.

The field 212 is an injected code type field that indicates whether the page corresponding to a given row stores injected code. For example, the field 212 for the row 210A is false, because the code 204 stored in the page 202A is not code that has been injected by the management component 114 into the virtual machine 106. Likewise, the field 212 for the row 210N is false, because the code 206 stored in the page 202N is not injected code. By comparison, the field 212 for the row 210B is true, because the code 122 stored in the page 202B is code that has been injected by the management component 114 into the virtual machine 106.

The field 214 stores one or more permitted entry points for the injected code of a given row where the field 212 for this row indicates that the corresponding page stores injected code. Each permitted entry point can be an offset relative to a page at which execution of the injected code stored in the page can start. As such, the injected code cannot be entered—i.e., cannot have its execution start—at any point other than a permitted entry point specified in the field 214 for the row corresponding to the page storing the injected code. A permitted entry point thus references a particular code instruction within the injected code. Because the pages 202A and 202N do not store injected code, their corresponding rows 210A and 210N do not have values for the field 214. By comparison, the page 202B stores the injected code 122, such that the field 214 for the row 210B stores a permitted entry point, which is exemplarily depicted in FIG. 2 by the hexadecimal offset 0×ABCD.

When the management component 114 injects the code 122 into the virtual machine 106 by storing the code 122 within the page 202B of the memory 112, the component 114 thus indicates in the field 212 for the corresponding row 210B that the code 122 is injected code. That is, the management component 114 indicates in the field 202 of the row 210B corresponding to the page 202B that the code 122 has the injected code type. The management component 114 also indicates within the field 214 for the row 210B a permitted entry point within the injected code 122.

The processor 108 that is to execute the injected code 122 is to reject entry into the code 122 except at the permitted entry point specified within the field 214 for the row 210B. For instance, the processor 108 may examine when the instruction pointer 216 of the processor 108 changes. The processor 108 examines a change in the instruction pointer 216 to detect whether the instruction pointer 216 is transitioning from code other than the injected code 122 to the injected code 122. Furthermore, in response to such detection, the processor 108 may raise an exception where the instruction pointer 216 is transitioning to a point within the injected code 122 other than a permitted entry point specified in the field 214 for the row 210B. By raising an exception, the processor 108 does not execute the injected code 122.

For example, the processor 108 may currently be executing the code 204 stored in the page 202A. At some point, the code 204 may branch to a code instruction within the injected code 122 stored in the page 202B. At that time, the processor 108 detects that its instruction pointer 216 is now pointing to the injected code 122. The processor 108 determines whether the code instruction of the injected code 122 to which the instruction pointer 216 is now pointing is a permissible entry point specified within the field 214 for the row 210B corresponding to the page 202B. If it is, then the processor 108 begins executing the injected code 122 at this code instruction. If the instruction pointer 216 of the processor 108 is not pointing to a permissible entry point, however, then the processor 108 raises an exception, and does not execute the injected code 122.

The processor 108 may also examine a change in the instruction pointer 216 to detect whether the instruction pointer 216 is transiting from the injected code 122 to code other than the injected code 122. In response to such detection, the processor 108 is to create another permitted entry point within the injected code 122 just after where the injected code 122 transitions to the other code. This new permitted entry point is also stored in the field 214 for the row 210B corresponding to the page 202B storing the injected code 122. The new permitted entry point may overwrite the existing permitted entry point previously stored in the field 214 for the row 210B, or it may be added to the existing permitted entry point already stored in the field 214 for the row 210B. When the instruction pointer 216 transitions back to the injected code at the new permitted entry point, the new permitted entry point is then removed from the field 214 for the row 210B.

For example, the processor 108 may currently be executing the injected code 122 stored in the page 202B. At some point, the injected code 122 may call a subroutine within the code 206 stored in the page 202N. At that time, the processor 108 detects that its instruction pointer 216 is now pointing to the code 206. The processor 108 creates a new permitted entry point into the injected code 122 just after the point within the injected code 122 at which the subroutine was called, and stores the new permitted entry point into the field 214 for the row 210B. When the subroutine within the code 206 returns back to the injected code 122, the processor 108 detects this change, and verifies that the injected code 122 is being returned back to the new permitted entry point, at which time the processor 108 removes this permitted entry point from the field 214 for the row 210B.

The approach described in relation to FIG. 2 ensures that security precautions embedded within the injected code 122 are not circumvented by the virtual machine 106. The virtual machine 106 cannot bypass such security precautions, because the virtual machine 106 is forced to begin execution of the injected code 122 at specified permitted entry points. However, the approach described in relation to FIG. 2 still permits the injected code 122 to utilize subroutines contained in non-injected code, such as within the code 206. This is because when the injected code 122 calls such a subroutine, the point within the injected code 122 at which execution of the injected code 122 is to resume once the subroutine is finished is also dynamically but temporarily stored as a permitted entry point.

As noted above, the injected code 122 may be specific to the hardware device 116, such that injection of the code 122 into the virtual machine 106 enables the virtual machine 106 to access the hardware device 116. The processor 108 is to indicate whether the current page 202 of the memory that the processor 108 is executing has the injected code type. That is, the processor 108 is to indicate the page 202 that stores the code that the processor 108 is currently executing.

As also noted above, in the direct mode the virtual machine 106 accesses the hardware device 106 via MMIO requests formulated by the injected code 122. The processor 108 executes these requests by accessing memory to which the hardware device 116 is mapped, through the memory controller 120. In FIG. 2, this process is depicted by the memory controller 120 interfacing the processor 108 to the hardware device 116.

The management component 114 therefore modifies the memory controller 120 so that MMIO requests originate from code that is stored in a page 202 of the memory 112 that does not have the injected code type. When the processor 108 attempts to access the memory to which the hardware device 116 is mapped, the memory controller 120 receives indication from the processor 108 as to the type of page 202 that contains the code that the processor is currently accessing. If this page 202 does not contain injected code—that is, if the page 202 has the injected code type—then the memory controller 120 blocks the MMIO request in question. By comparison, if this page 202 contains injected code—that is, if the page 202 does not have the injected code type—then the memory controller 120 allows and does not block the MMIO request.

For example, if the processor 108 is currently executing the injected code 122 and in so doing issues an MMIO request, then the memory controller 120 allows the request, because the page 202B containing the injected code 122 has the injected code type. This is indicated by a solid line between the injected code 122 and the hardware device 116 in FIG. 2. As another example, if the processor 108 is currently executing the code 204 or the code 206 and in so doing issues an MMIO request, then the memory controller 120 blocks the request, because the pages 202A and 202N containing the code 204 and 204 do not have the injected code type. This is indicated by the solid lines between the code 204 and 206 and the hardware device 116 being interrupted by an X in FIG. 2.

The described approach also ensures that security precautions embedded within the injected code 122 are not circumvented by the virtual machine 106. The virtual machine 106 cannot bypass such precautions by simply copying the injected code 122 to a different page 202 and then modifying the copied version of the code 122 to remove the security precautions. This is because when the resulting modified version of the code 122 is executed by the processor 108, any MMIO requests issued by the processor 108 are blocked by the memory controller 120, since the modified version of the code 122 is stored in a page 202 that does not have the injected code type. Just the management component 114, and not the virtual machine 106, can assign a page 202 with the injected code type.

Therefore, while the virtual machine 106 can copy and then modify the injected code 122, the copied and/or modified version of the code 202 cannot be used to access the hardware device 116. This is because MMIO requests resulting from the copied and/or modified version of the code 202 are blocked by the memory controller 120. It is noted that the original copy of the injected code 122, which is injected by the management component 114 into the virtual machine 106 and stored within the page 202B that is indicated as having the injected code type, may be marked as read-only from the perspective of the virtual machine 108. As such, the virtual machine 108 cannot modify the injected code 122 as stored within the page 202B. Modification of a copy of the injected code 122 by the virtual machine 108 will not be stored within a page 202 that has the injected code type, such that the resulting code will have its MMIO requests blocked by the memory controller 120.

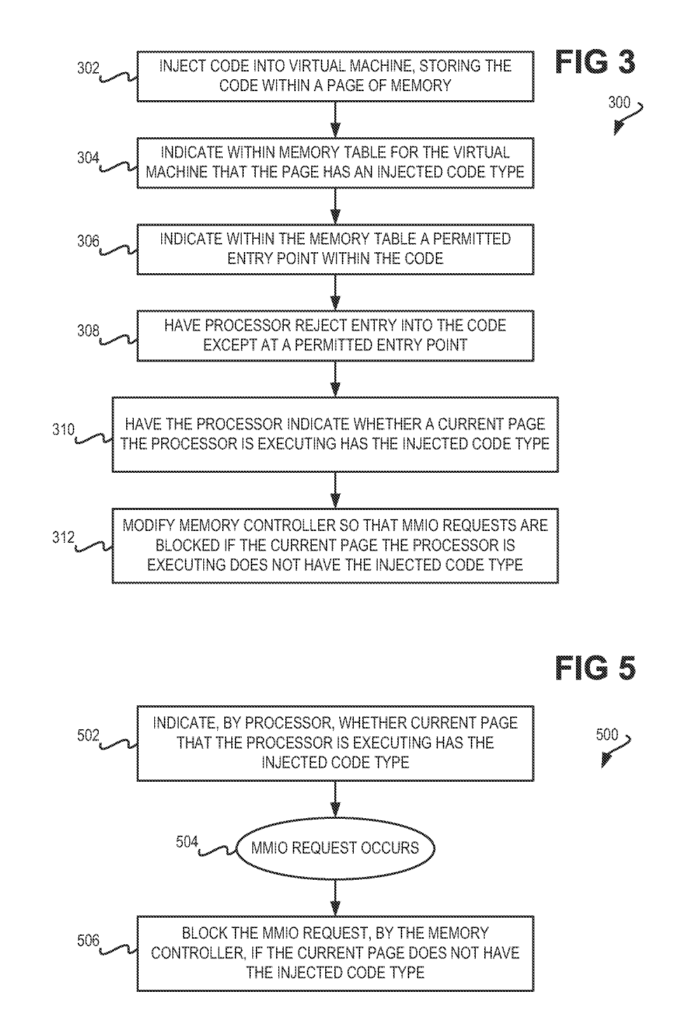

FIG. 3 shows a method 300 that is performed at least in part by the management component 114, according to an example embodiment of the disclosure. As such, the method 300 can be implemented by one or more computer programs stored on a tangible and non-transitory computer-readable data storage medium, where execution of the computer programs by a processor causes the method 300 to be performed. The computer programs in this respect implement and/or are part of the management component 114.

The management component 114 injects the code 122 into the virtual machine 106 (302), storing the injected code 122 within the page 202B of the memory 112. The management component 114 indicates within the field 212 for the row 210B of the memory table 208 that the page 202B has the injected code type (304). The management component 114 also indicates within the field 214 for the row 210B a permitted entry point within the injected code 122 (306).

The processor 108 is to reject entry into the injected code 122 except at a permitted entry point (308). The processor 108 is also to indicate whether the current page 202 that the processor 108 is executing has the injected code type (310). The management component 114 further modifies the memory controller 120 to block MMIO requests from the processor 108 if the current page 202 that the processor is executing does not have the injected code type (312).

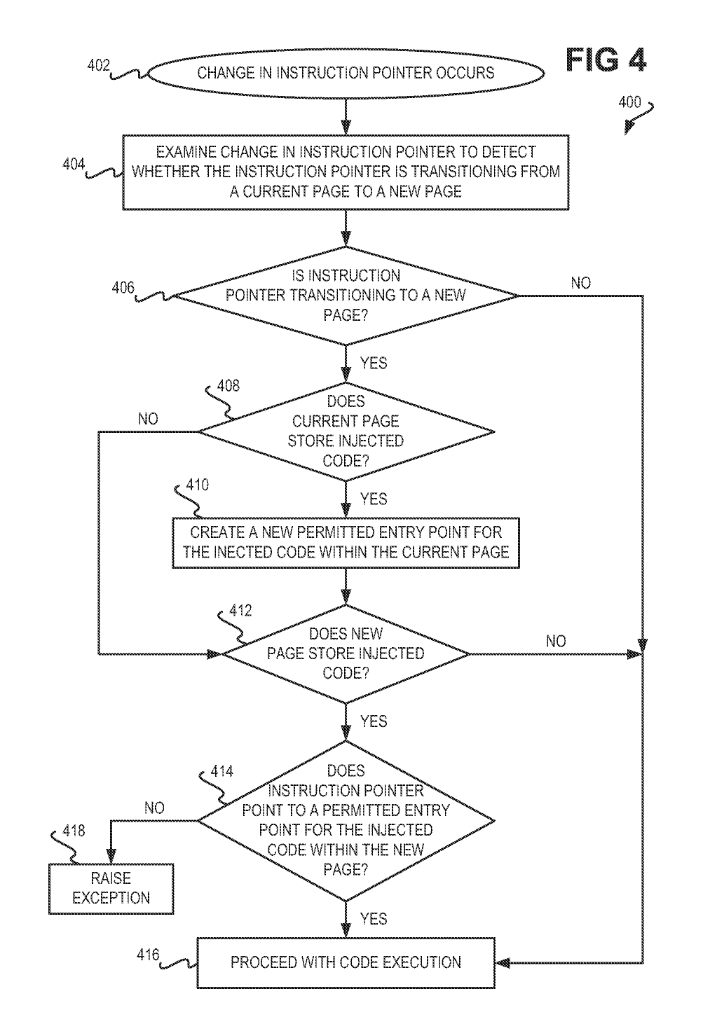

FIG. 4 shows a method 400 of the operation of the processor 108 pursuant to part 308 of the method 300, according to an example embodiment of the disclosure. A change in the instruction pointer 216 occurs (402). This change results from the current code instruction having been executed by the processor 108 such that the pointer 216 now points to the next code instruction to be executed by the processor 108.

The processor 108 examines the change in the instruction pointer 216 to detect whether the instruction pointer 216 is transitioning from a current page 202 to a new page 202 within the memory 112 (404). That is, the change in the instruction pointer 216 is examined to detect whether the prior code instruction executed by the processor 108 is stored in one page 202, and the next code instruction to be executed by the processor 108 is stored in another page 202. If the instruction pointer 216 is not transitioning to a new page 202 (406), then the method 400 ends with the processor 108 proceeding with execution of the next code instruction (416).

However, if the instruction pointer 216 is transitioning from a current page 202 to a new page 202 (406), and if the current page 202 stores injected code (408), then the processor 108 creates a new permitted entry point for the injected code within the current page 202 (410). The new permitted entry point is the code instruction within the current page 202 immediately after the code instruction within the current page 202 that has just been executed by the processor 108. The new permitted entry point permits the processor 108 to return to the current page 202 when the code on the new page 202 has finished being executed.

From part 410, or where the current page 202 does not store injected code in part 408, the method 400 determines whether the new page 202 to which the instruction pointer 216 is transitioning stores injected code (412). If the new page 202 does not store injected code (412), then the method 400 ends with the processor 108 proceeding with execution of the next code instruction (416). However, if the new page 202 does store injected code (412), and if the instruction pointer 216 does not point to a permitted entry point for the injected code within the new page 202 (414), then the processor 108 raises an exception (418), such that the injected code within the new page 202 is not executed. By comparison, if instruction pointer 216 does point to a permitted entry point for the injected code within the new page 202 (414), then the method 400 ends with the processor 108 proceeding with execution of the next code instruction (416).

FIG. 5 shows a method 500 of the operation of the processor 108 and the memory controller 120 pursuant to parts 310 and 312 of the method 300, according to an example embodiment of the disclosure. The method 500 pertains to the situation where the injected code 122 is specific to a hardware device 116, so that the virtual machine 106 can access the hardware device 116 in the direct mode.

When the processor 108 is executing a code instruction on a given page 202, the processor 108 indicates whether this current page 202 has the injected code type (502). It is presumed that the code instruction being executed results in an MMIO request occurring for access to the hardware device 116 (504). In response, the memory controller 120 blocks the MMIO request if the current page 202 does not have the injected code type (506). Stated another way, the MMIO request is blocked if the code instruction being executed is not part of the injected code 122.

We claim:

1. A system comprising:
a processor;
memory having a page to store code executable by the processor; and,
a management component to inject the code into a virtual machine, and to indicate within a memory table for the virtual machine that the page of the memory has an injected code type.

2. The system of claim 1, wherein the management component is further to indicate within the memory table a permitted entry point within the code.

3. The system of claim 2, wherein the processor is to reject entry into the code except at the permitted entry point.

4. The system of claim 3, wherein the page of the memory within which the code is storable is a first page of the memory, and the memory further includes a second page that does not have the injected code type,
and wherein processor is to:
examine a change in an instruction pointer referencing a next code instruction to be executed by the processor to detect whether the instruction pointer is transitioning from the second page to the first page; and
response to detecting that the instruction pointer is transitioning from the second page to the first page, raise an exception where the instruction pointer is transitioning to a point within the code other than the permitted entry point,

5. The system of claim 3, wherein the permitted entry point a first permitted entry point, the page of the memory within which the code is storable is a first page of the memory, and the memory further includes a second page that does not have the injected code type,
and wherein the processor is to:
examine a change in an instruction pointer referencing a next code instruction to be executed by the processor to detect whether the instruction pointer is transitioning from the first page to the second page; and
responsive to detecting that the instruction pointer is transitioning from the first page to the second page, create a second permitted entry point within the code just after where the code transitions to the second page.

6. The system of claim 1, wherein the processor is to indicate whether a current page of the memory that the processor is executing has the injected code type.

7. The system of claim 6, further comprising a memory controller for the memory,
wherein the code is to permit the virtual machine to communicate with a hardware device via a portion of the memory and by using a memory-mapped input/output (MMIO) request executable by the processor,
and wherein the management component is further to modify the memory controller so that the MMIO request is blocked where the current page of the memory that the processor is executing does not have the injected code type.

8. A computer-readable medium having one or more computer programs stored thereon for execution by a processor to perform a method comprising:
injecting code executable by the processor into a virtual machine, such that the code is stored within a page of the memory; and,
indicating within a memory table for the virtual machine that the page of the memory has an injected code type.

9. The computer-readable medium of claim 8, wherein the page of the memory within which the code is stored is a first page of the memory, the memory further includes a second page that does not have the injected code type, and the method further comprises:
indicating within the memory table a permitted entry point within the code; and,
having the processor reject entry into the code except at the permitted entry point such that the processor is to:
examine a change in an instruction pointer referencing a next code instruction to be executed by the processor to detect whether the instruction pointer is transitioning from the second page to the first page; and
responsive to detecting that the instruction pointer is transitioning from the second page to the first page, raise an exception where the instruction pointer is transitioning to a point within the code other than the permitted entry point,

10. The computer-readable medium of claim 9, wherein the change is a first change, the permitted entry point is a first permitted entry point, and wherein the processor is to reject entry into the code except at the permitted entry point further such that the processor is to:
examine a second change in the instruction pointer referencing a next code instruction to be executed by the processor to detect whether the instruction pointer is transitioning from the first page to the second page; and
responsive to detecting that the instruction pointer is transitioning from the first page to the second page, create a second permitted entry point within the code just after where the code transitions to the second page.

11. The computer-readable medium of claim 8, wherein the code is to permit the virtual machine to communicate with a hardware device via a portion of the memory and by using a memory-mapped (MMIO) request executable by the processor, and the method further comprises:
having the processor indicate whether a current page of the memory that the processor is executing has the injected code type: and,
modifying the memory controller so that the MMIO request is blocked where the current page of the memory that the processor is executing does not have the injected code type.

12. A method comprising:
injecting, by a management component implemented at least by a processor, code executable by the processor into a virtual machine, such that the code is stored within a page of the memory; and,
indicating within a memory table for the virtual machine, by the management component, that the page of the memory has an injected code type.

13. The method of claim 12, wherein the page of the memory within which the code is stored is a first page of the memory, the memory further includes a second page that does not have the injected code type, and the method further comprises:
indicating within the memory table, by the management component, a permitted entry point within the code; and,
rejecting entry into the code, by the processor, except at the permitted entry point, comprising:
examining a change in an instruction pointer referencing a next code instruction to be executed by the processor to detect whether the instruction pointer is transitioning from the second page to the first page; and
responsive to detecting that the instruction pointer is transitioning from the second page to the first page, raising an exception where the instruction pointer is transitioning to a point within the code other than the permitted entry point.

14. The method of claim 13, wherein the change is a first change, the permitted entry point is a first permitted entry point, and rejecting entry into the code except at the permitted entry point further comprises:
examining a second change in the instruction pointer referencing a next code instruction to be executed by the processor to detect whether the instruction pointer is transitioning from the first page to the second page; and
responsive to detecting that the instruction pointer is transitioning from the first page to the second page, creating a second permitted entry point within the code just after where the code transitions to the second page.

15. The method of claim 12, wherein the code is to permit the virtual machine to communicate with a hardware device via a portion of the memory and by using a memory-mapped (MMIO) request executable by the processor, and the method further comprises:
indicating, by the processor, whether a current page of the memory that the processor is executing has the injected code type; and,
blocking the MMIO request, by the memory controller, where the current page of the memory that the processor is executing does not have the injected code type.
